(19) United States
(12) Patent Application Publication
(10) Pub. No.: US 2024/0046614 A1
(43) Pub. Date: Feb. 8, 2024

(54) COMPUTER-IMPLEMENTED METHOD FOR GENERATING RELIABILITY INDICATIONS FOR COMPUTER VISION

(71) Applicant: Robert Bosch GmbH, Stuttgart (DE)

(72) Inventors: Christian Heinzemann, Vellmar (DE); Christoph Gladisch, Renningen (DE); Matthias Woehrle, Bietigheim-Bissingen (DE); Ulrich Seger, Leonberg-Warmbronn (DE)

(21) Appl. No.: 18/264,569

(22) PCT Filed: Jan. 25, 2022
(86) PCT No.: PCT/EP2022/051569

§ 371 Date: Aug. 7, 2023

(30) Foreign Application Priority Data
Feb. 9, 2021 (DE) 10 2021 201 178.0

(51) Int. Cl. G06V 10/764; G06V 20/40; G06V 20/56; G06V 10/82

(52) U.S. Cl. CPC G06V 10/764; G06V 20/41; G06V 20/56; G06V 10/82

(57) ABSTRACT

A computer-implemented method for generating reliability indication data of a computer vision model. The method includes: obtaining visual data including an input image or sequence representing an observed scene, the visual data being characterizable by a first set of visual parameters; analysing the observed scene in the visual data using a computer vision reliability model sensitive to a second set of visual parameters, the second set of visual parameters includes a subset of the first set of visual parameters, and is obtained from the first set of visual parameters according to a sensitivity analysis applied to a plurality of parameters in the first set of visual parameters, the sensitivity analysis is performed during an offline training phase of the computer vision reliability model; generating reliability indication data of the observed scene using the analysis of the observed scene; and outputting the reliability indication data of the computer vision model.

### FIELD

The present invention relates to a computer-implemented method for generating reliability indication data of a computer vision model, and an associated apparatus, computer-implemented method for training a computer vision reliability model, and an associated computer program element, computer readable medium, and an autonomous system.

### BACKGROUND INFORMATION

Computer vision concerns how computers can automatically gain high-level understanding from digital images or videos. Computer vision systems are finding increasing application to the automotive or robotic vehicle field. Computer vision can process inputs from any interaction between at least one detector and the environment of that detector. The environment may be perceived by the at least one detector as a scene or a succession of scenes.

In particular, interaction may result from at least one electromagnetic source which may or may not be part of the environment. Detectors capable of capturing such electromagnetic interactions can, for example, be a camera, a multi-camera system, a RADAR or LIDAR system.

In automotive computer vision systems, systems computer vision often has to deal with open context despite being safety-critical. It is, therefore, important that safeguarding means are provided when applying computer vision models/functions.

### SUMMARY

According to a first aspect of the present invention, there is provided a computer-implemented method for generating reliability indication data of a computer vision model. According to an example embodiment of the present invention, the method includes:
obtaining visual data comprising an input image or image sequence representing an observed scene, wherein the visual data is characterizable by a first set of visual parameters;
analysing the observed scene comprised in the visual data using a computer vision reliability model sensitive to a second set of visual parameters,
wherein the second set of visual parameters comprises a subset of the first set of visual parameters, wherein the second set of visual parameters is obtained from the first set of visual parameters according to a sensitivity analysis applied to a plurality of parameters in the first set of visual parameters, wherein the sensitivity analysis is performed during a prior training phase of the computer vision reliability model;
generating reliability indication data of the observed scene using the analysis of the observed scene; and
outputting the reliability indication data of the computer vision model.

The method according to the first aspect of the present invention advantageously provides an online safety (or reliability) monitor capable of independently monitoring a visual scene according to a visual parameter space. The online safety monitor identifies when an autonomous system using the online safety monitor is observing a scene in conditions described by visual parameters that imply that a computer vision model will perform unreliably. In other words, a previous global sensitivity analysis of the computer vision model performed during training of the online safety monitor may have determined that for a given set of visual input data, the computer vision model classifies or predicts visual elements within the visual input data at a high variance, indicating unreliability of the computer vision model when observing a scene described by such visual parameters.

Testing computer vision models or evaluating their performance statistically is challenging because the input space is large. Theoretically, the input space consists of all possible images defined by the combination of possible pixel values given the input resolution. In reality, image datasets comprise real (captured by physical camera), or synthetic (obtained using 3D rendering, image augmentation, or image synthesis, for example) images.

Therefore, the present invention provides an automatic system that may use image input from an autonomous or semi-autonomous system such as a vehicle or robot to detect when an image processing subsystem of the autonomous or semi-autonomous system may be operating in an unsafe mode.

A practical example is that a computer vision model parameterised by parameters including the angle of the sun may accurately identify the content of road signs when the sun is parameterised as being angled from a direction substantially behind an ego-vehicle, enabling good comprehension of forward-facing road-signs. In this case, visual elements of scenes can be predicted as having a low variance, indicating reliability of computer vision model.

Alternatively, the sun may be parameterised as being angled directly towards an ego vehicle, causing forward-facing road signs to be obscured owing to forward glare. In this case, visual elements of scenes can be characterised as having a high variance, indicating unreliability of a computer vision model in conditions where forward glare is significant. A skilled reader will appreciate that many different combinations of visual parameter may lead to high or low variance of computer vision model results, and the foregoing is an example.

Generally, different sets of visual parameters (defining the world model or ontology) for testing or statistically evaluating the computer vision model can be defined and their implementation or exact interpretation may vary. According to the present invention, a methodology is provided that enforces online reliability decision-making based on empirical results.

Owing to the aforementioned size of the parameter space, it is difficult to verify the entire parameter space comprehensively. According to the first aspect of the present invention, given a set of visual parameters and a computer vision function as input, a sorted list of visual parameters may be provided. By selecting a sub list of visual parameters from the sorted list, a reduced input model (ontology) is defined.

According to the first aspect of the present invention, online monitoring of the performance of a computer vision model is proposed to monitor the safety or reliability of an autonomous system during operation. Based on a sensitivity analysis, safety or reliability conditions of a computer vision model are analysed. A computational system, for example a deep neural network, is trained to detect visual conditions causing a computer vision model to perform at a heightened or high variance. For example, the computational system can identify a distributional shift. Such conditions are monitored during operation of a computer vision model. If the computer vision model operates under a condition where the global sensitivity analysis demonstrates low performance then the technique signals a low confidence or warning to subsystems that use the computer vision model.

To enlarge an example of foregoing paragraphs, if the reliability or safety monitor discussed herein was applied to the problem of verifying the detection of speed limits on road signs, the reliability or safety monitor would signal that a given speed limit had been detected with a degree of certainty above a first threshold such as 90% if the sun was positioned in the sky behind the ego-vehicle. Alternatively, the reliability or safety monitor would signal that given speed limit had been detected with a degree of certainty below a second threshold such as 10% if the sun was positioned in the sky directly in front of the ego-vehicle.

According to a second aspect of the present invention, there is provided a computer-implemented method for training a computer vision reliability model. According to an example embodiment of the present invention, the method includes:
sampling a set of visual parameters from a visual parameter specification;
obtaining a set of items of visual data, and providing a set of items of groundtruth data corresponding to the set of items of visual data based on the sampled set of visual parameters, wherein the set of items of visual data and the set of items of groundtruth data form a training data set;
iteratively training a first machine learning model to analyse at least one item of visual data from the set of items of visual data, and to output a prediction of a mapping of the at least one item of visual data to a subset of the set of visual parameters used to generate the item of visual data;
iteratively training a second machine learning model to predict reliability indication data of the prediction of the mapping made by the first machine learning model, wherein the reliability indication data is obtained by comparing the prediction of the mapping from the first machine learning model with a corresponding item of groundtruth data from the training data set.

In an example embodiment of the present invention, the computer vision model of the first aspect is trained according to the method of the second aspect.

According to a third aspect of the present invention, there is provided a data processing apparatus configured to generate reliability indication data of a computer vision model. According to an example embodiment of the present invention, the data processing apparatus includes an input interface, a processor, a memory, and an output interface. The input interface is configured to obtain visual data comprising an input image or image sequence representing an observed scene, wherein the visual data is characterizable by a first set of visual parameters. The processor is configured to analyse the observed scene comprised in the visual data using a computer vision reliability model sensitive to a second set of visual parameters. The second set of visual parameters comprises a subset of the first set of visual parameters, wherein the second set of visual parameters is obtained from the first set of visual parameters according to a sensitivity analysis applied to a plurality of parameters in the first set of visual parameters, wherein the sensitivity analysis is performed during a prior training phase of the computer vision reliability model. The processor is configured to generate reliability indication data of the observed scene using the analysis of the observed scene. The output interface is configured to output the reliability indication data of the computer vision model.

According to a fourth aspect of the present invention, there is provided a computer program comprising machine-readable instructions which, when executed by a processor, is capable of carrying out the computer-implemented method according to the first or second aspects of the present invention.

According to a fifth aspect of the present invention, there is provided a computer readable medium comprising at least one of the computer programs according to the fourth aspect of the present invention.

According to a sixth aspect of the present invention, there is provided an autonomous system. According to an example embodiment of the present invention, the autonomous system includes a sensor configured to provide visual data comprising an input image or image sequence representing an observed scene, and a data processing apparatus configured to generate reliability indication data of a computer vision model according to the second aspect. The autonomous system optionally further comprises a motion control subsystem, and the autonomous system is optionally configured to generate or alter a motion command provided to the motion control subsystem based on reliability indication data obtained using the data processing apparatus.

Example embodiments of the aforementioned aspects are disclosed herein.

Computer vision concerns with how computers can automatically gain high-level understanding from digital images or videos. In particular, computer vision may be applied in the automotive engineering field to detect road signs, and the instructions displayed on them, or obstacles around a vehicle. An obstacle may be a static or dynamic object capable of interfering with the targeted driving manoeuvre of the vehicle. Along the same lines, aiming at avoiding getting too close to an obstacle, an important application in the automotive engineering field is detecting a free space (e.g., the distance to the nearest obstacle or infinite distance) in the targeted driving direction of the vehicle, thus figuring out where the vehicle can drive (and how fast).

To achieve this, one, or more of object detection, semantic segmentation, 3D depth information, navigation instructions for autonomous system may be computed. Another common term used for computer vision is computer perception. In fact, computer vision can process inputs from any interaction between at least one detector and its environment. The environment may be perceived by the at least one detector as a scene or a succession of scenes. In particular, interaction may result from at least one electromagnetic source (e.g. the sun) which may or may not be part of the environment. Detectors capable of capturing such electromagnetic interactions can e.g. be a camera, a multi-camera system, a RADAR or LIDAR system, or infra-red. An example of a non-electromagnetic interaction could be sound waves to be captured by at least one microphone to generate a sound map comprising sound levels for a plurality of solid angles, or ultrasound sensors.

Computer vision is an important sensing modality in automated or semi-automated driving. In the following specification, the term “autonomous driving” refers to fully autonomous driving, and also to semi-automated driving where a vehicle driver retains ultimate control and responsibility for the vehicle. Applications of computer vision in the context of autonomous driving and robotics are detection, tracking, and prediction of, for example: drivable and non-drivable surfaces and road lanes, moving objects such as vehicles and pedestrians, road signs and traffic lights and potentially road hazards.

Computer vision has to deal with open context. It is difficult to experimentally model all possible visual scenes. Machine learning—a technique which automatically creates generalizations from input data may be applied to computer vision. The generalizations required may be complex, requiring the consideration of contextual relationships within an image.

For example, a detected road sign indicating a speed limit is relevant in a context where it is directly above a road lane that a vehicle is travelling in, but it might have less immediate contextual relevance if it is not above the road lane that the vehicle is travelling in.

Deep learning-based approaches to computer vision have achieved improved performance results on a wide range of benchmarks in various domains. In fact, some deep learning network architecture implement concepts such as attention, confidence, and reasoning on images. As industrial application of complex deep neural networks (DNNs) increases, there is an increased need for verification and validation (V&V) of computer vision models, especially in partly or fully automated systems where the responsibility for interaction between machine and environment is unsupervised. Emerging safety norms for automated driving, such as for example, the norm “Safety of the intended functionality” (SOTIF), may contribute to the safety of a CV-function.

One or more visual parameters define a visual state of a scene because it or they contain information about the contents of the observed scene and/or represent boundary conditions for capturing and/or generating the observed scene.

The visual parameters can be for example: camera properties (e.g. spatial- and temporal-sampling, distortion, aberration, colour depth, saturation, noise etc.), LIDAR or RADAR properties (e.g., absorption or reflectivity of surfaces, etc.), light conditions in the scene (light bounces, reflections, light sources, fog and light scattering, overall illumination, etc.), materials and textures, objects and their position, size, and rotation, geometry (of objects and environment), parameters defining the environment, environmental characteristics like seeing distance, precipitation-characteristics, radiation intensities (which are suspected to strongly interact with the detection process and may show strong correlations with performance), image characteristics/statistics (such as contrast, saturation, noise, etc.), domain-specific descriptions of the scene and situation (e.g. cars and objects on a crossing), etc. Many more parameters are possible.

These parameters can be seen as an ontology, taxonomy, dimensions, or language entities. They can define a restricted view on the world or an input model. A set of concrete images can be captured or rendered given an assignment/a selection of visual parameters, or images in an already existing dataset can be described using the visual parameters. The advantage of using an ontology or an input model is that for testing an expected test coverage target can be defined in order to define a test end-criterion, for example using t-wise coverage, and for statistical analysis a distribution with respect to these parameters can be defined.

Images, videos, and other visual data along with co-annotated other sensor data (GPS-data, radiometric data, local meteorological characteristics) can be obtained in different ways. Real images or videos may be captured by an image capturing device such as a camera system. Real images may already exist in a database and a manual or automatic selection of a subset of images can be done given visual parameters and/or other sensor data. Visual parameters and/or other sensor data may also be used to define required experiments. Another approach can be to synthesize images given visual parameters and/or other sensor data. Images can be synthesized using image augmentation techniques, deep learning networks (e.g., Generative Adversarial Networks (GANs), Variational Autoencoders (VAEs)), and 3D rendering techniques. A tool for 3D rendering in the context of driving simulation is for example the CARLA tool (Koltun, 2017, available at www.arXiv.org: 1711.03938).

A visual data set of the observed scenes is a set of items representing either an image or a video, the latter being a sequence of images, such as JPEG or GIF images.

A computer vision model is a function (i.e. a map) parametrized by model parameters that upon training can be learned based on the training data set using machine learning techniques. The computer vision model is configured to at least map an item of visual data or a portion, or subset thereof to an item of predicted data. One or more visual parameters define a visual state in that they contain information about the contents of the observed scene and/or represent boundary conditions for capturing and/or generating the observed scene. A latent representation of the computer vision model is an output of an intermediate (i.e. hidden) layer or a portion thereof in the computer vision model.

An item of groundtruth data corresponding to one item of visual data is a classification and/or regression result that the computer vision model is intended to output. In other words, the groundtruth data represents a correct answer of the computer vision model when input with an item of visual data showing a predictable scene or element of a scene. The term image may relate to a subset of an image, such as a segmented road sign or obstacle. The correct answer may also comprise/be a probability of a classification result.

This present invention provides an online safety monitor or reliability monitor configured to monitor an extended computer vision model implemented, for example, in a deep neural-like network which is configured to integrate verification results into the design of the computer vision model. The specification proposes means to identify and prioritise critical visual parameters whose presence in an input image can be an indicator of unreliability of a computer vision model classification or regression result, for example using an offline global sensitivity analysis that is then then used to train a neural network that provides the online safety monitor. The term “offline” means that the safety monitor is not being used to provide live monitoring of the safety of a vehicle during operation.

### BRIEF DESCRIPTION OF THE DRAWINGS

FIG. 1 schematically illustrates the high-level development process of an online reliability monitor, according to an example embodiment of the present invention.

FIG. 2 schematically illustrates a computer-implemented method according to the first aspect of the present invention.

FIG. 3 schematically illustrates a computer-implemented training method according to the second aspect of the present invention.

FIG. 4 schematically illustrates an example of an autonomous system comprising a safety monitor configured to computer reliability indication data, according to the present invention.

FIG. 5 schematically illustrates a general flow diagram according to an example embodiment of the present invention.

FIG. 6 schematically illustrates training a machine learning model configured to function as a reliability monitor, according to an example embodiment of the present invention.

FIG. 7 schematically illustrates an example of global sensitivity analysis of visual parameters for computer vision functions, according to the present invention.

FIG. 8 schematically illustrates an example of global sensitivity analysis of visual parameters, according to the present invention.

FIG. 9 schematically illustrates an apparatus according to the third aspect of the present invention.

FIG. 10 schematically illustrates an autonomous system according to the sixth aspect of the present invention.

### DETAILED DESCRIPTION OF EXAMPLE EMBODIMENTS

Computer vision models identify elements in scenes of images or videos. For example, in automotive application, a image sensor such as a camera with a road traffic sign within its field of view may identify the road traffic sign is an element of a scene, and furthermore may identify a speed displayed by the road traffic sign as a sub-element of the scene. Other visual parameters, such as the direction of the sun relative to an ego-vehicle, more general weather conditions, the velocity of the ego-vehicle relative to the road traffic sign and the like may affect the comprehension of the road traffic sign as an element of the scene by a computer-implemented computer vision function.

The visual parameter space that affects the performance of a computer vision model is typically very large, and cannot be completely verified a priori, or “off-line”. Therefore, an “online” reliability monitor of a computer vision model is discussed in the specification. The reliability monitor observes a given image or sequence of images forming a scene, and reports to downstream functions the reliability of a prediction of the content of a scene, for example.

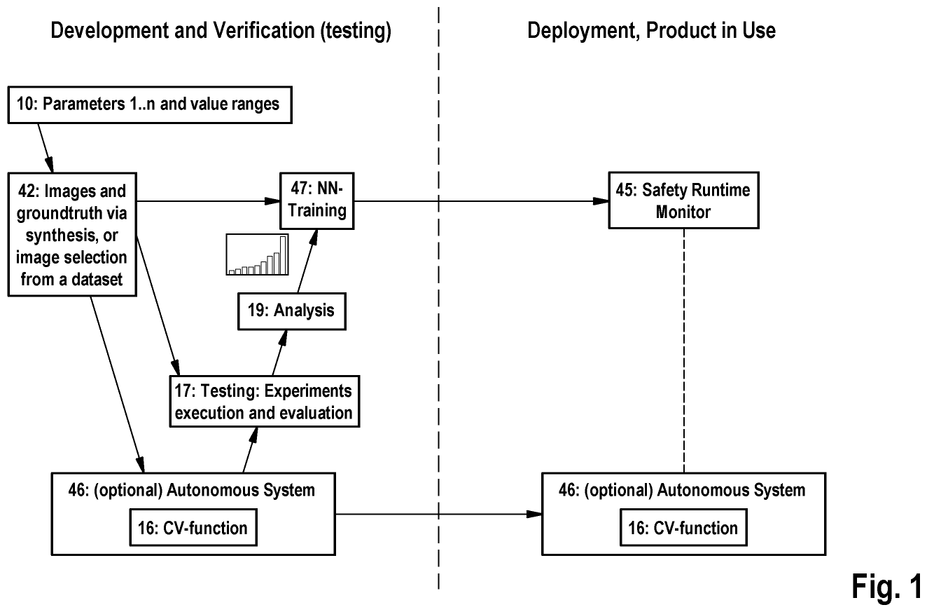

FIG. 1 schematically illustrates a development and verification process of a computer vision model. The illustrated model is applied in computer function development as the “V-model”.

Unlike in traditional approaches where development/design and validation/verification are separate tasks, according to the “V-model” development and validation/verification can be intertwined in that, in this example, the result from verification is fed back into the design of the computer vision model. A plurality of visual parameters 10 is used to generate a set of images and groundtruth (GT) 42. The computer vision model 16 is tested 17 and a (global) sensitivity analysis 19 is then applied to find out the most critical visual parameters 10, i.e., parameters which have the biggest impact on the performance 17 of the computer vision model. In particular, the computer vision model 16 is analysed 19 by comparing, for a plurality of input images within the visual parameter space, a performance score (such as a variance performance score). The results of the sensitivity analysis 19 may be employed when training 47 a further computer vision model 45 implementing a safety (or reliability) runtime monitor. For example, a specific computer vision model 16 may provide element prediction results caused by visual parameters having high variance over the groundtruth (in other words, be unreliable). The safety runtime monitor 45 is trained to recognise similar visual parameters associated with a high variance over the ground truth. In this way, the safety status of an autonomous system 46 incorporating a computer vision model 16 may be accurately tracked during operation.

The safety runtime monitor 45 may be a part of an autonomous system 46, 400 that may be, for example, a self-driving vehicle, a semi-autonomous vehicle, an autonomous or semi-autonomous robot, an autonomous or semi-autonomous drone, and the like that can be integrated into the autonomous system 46, 400 or into the computer vision model 16 itself. The autonomous system 400.

It is difficult to test the computer vision model 16 on all possible combinations of visual parameter, and thus the safety monitor 45 extends the verification of the computer vision model over its full life-cycle and provides warnings to relevant systems during use (whilst the computer vision model is in use or “online”). A user of the computer vision model 16 or the autonomous system 46 can react to such warning. Optionally, the safety monitor is a computer vision model having a deep neural network 47 that is trained. However, the safety monitor also applies additional information based on a global sensitivity analysis 19 and classification of the inputs based on test results 17.

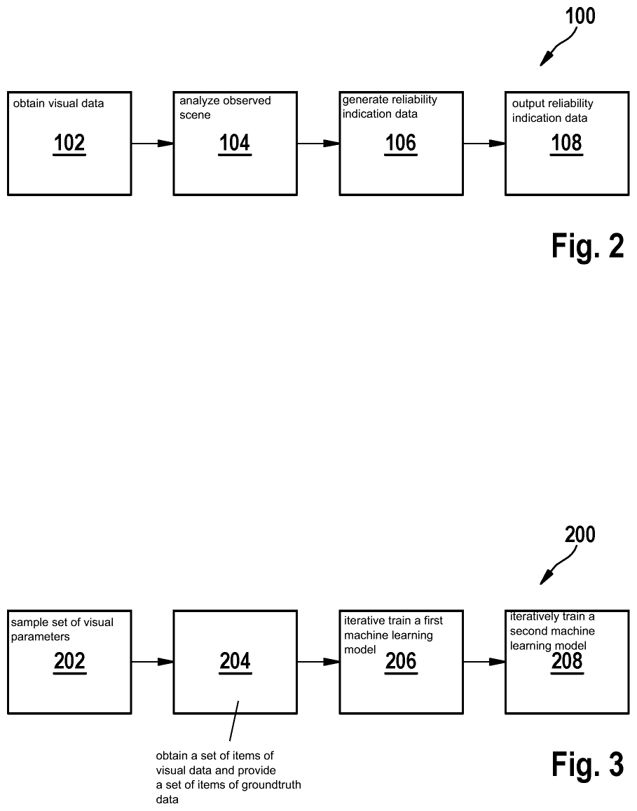

FIG. 2 schematically illustrates a computer-implemented method according to the first aspect.

According to the first aspect, there is provided a computer-implemented method 100 for generating reliability indication data of a computer vision model, comprising:
obtaining 102 visual data comprising an input image or image sequence representing an observed scene, wherein the visual data is characterizable by a first set of visual parameters;
analysing 104 the observed scene comprised in the visual data using a computer vision reliability model sensitive to a second set of visual parameters, wherein the second set of visual parameters comprises a subset of the first set of visual parameters, wherein the second set of visual parameters is obtained from the first set of visual parameters according to a sensitivity analysis applied to a plurality of parameters in the first set of visual parameters, wherein the sensitivity analysis is performed during a prior training phase of the computer vision reliability model;
generating 106 reliability indication data of the observed scene using the analysis of the observed scene; and
outputting 108 the reliability indication data of the computer vision model.

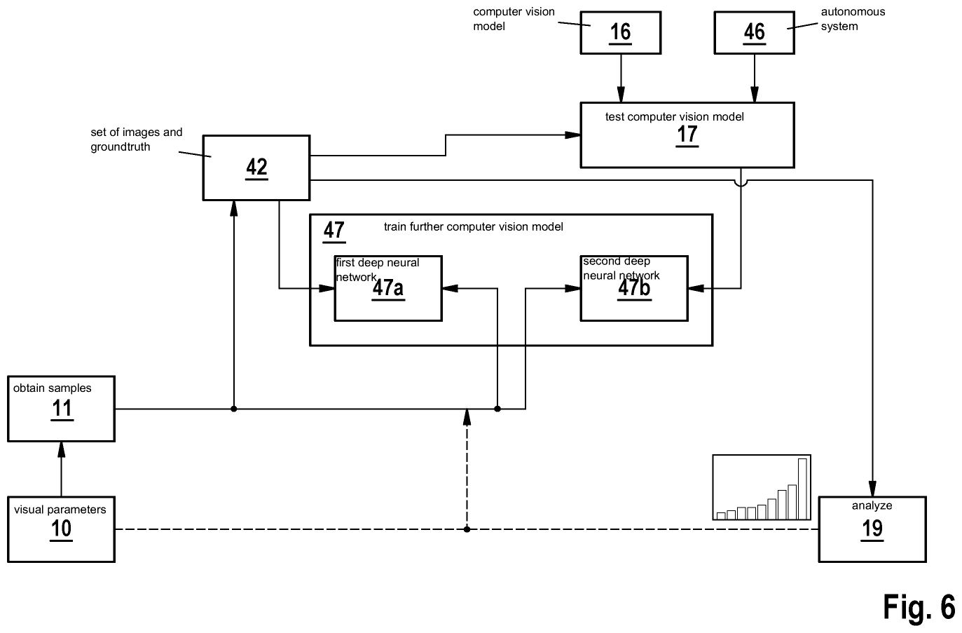

The analysis 104 of the observed scene is performed using one or more trained models, for example a first and second deep neural network 47a, 47b. The training of the deep neural networks is discussed at least in connection with the method of the second aspect and illustrated in FIG. 6.

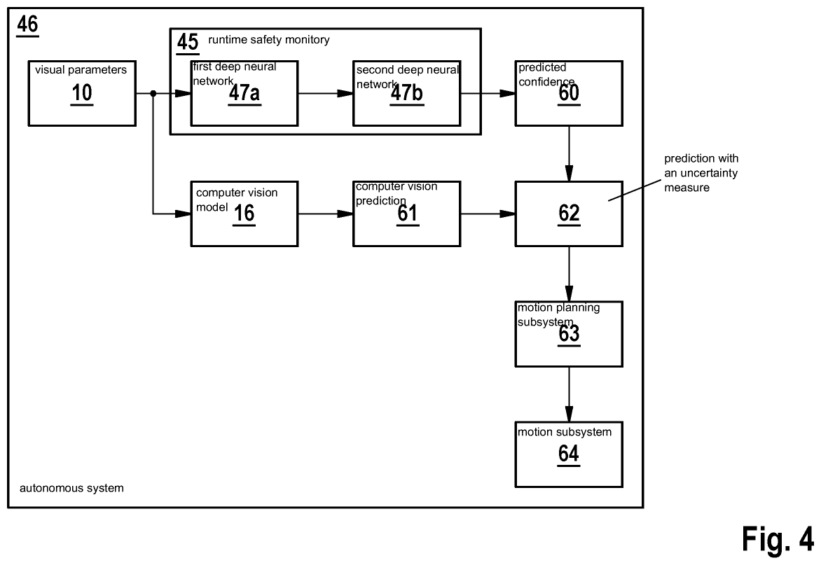

FIG. 4 schematically illustrates an example of generating reliability indication data within an autonomous system 46. The computer-implemented method 100 may be applied by, for example, a safety (or reliability) runtime monitor 45 provided within a data processing apparatus 300 comprised within autonomous system 46.

The safety runtime monitor 45 is configured to receive an input image or image sequence from cameras, RADAR, or LIDAR, for example. The safety runtime monitor 45 comprises a plurality of trained models capable of predicting the performance or uncertainty of a computer vision model 16. The safety runtime monitor 45 is configured to output a predicted confidence 60 or safety of a computer vision model 16. The predicted confidence is an example of the reliability indication data of the computer vision model. For example, the predicted confidence 60 may be a continuous variable representing a probability that a computer vision result is trustworthy. Alternatively, the predicted confidence 60 may be a binary result indicating a hard decision of whether or not to trust a computer vision result. The predicted confidence 60 or reliability indication data may be a conditional result, conditional on a subset of visual parameters. For example, an image prediction of a dark-coloured vehicle may be more reliable conditional on a visual parameter defining the time of day as being during daylight hours.

Although not essential, the safety runtime monitor 45 may, according to an embodiment, be operated “online” in parallel with a computer vision model 16 configured to receive the same image input as the safety runtime monitor 45. The computer vision model 16 is configured to generate a computer vision prediction 61 (comprising, for example, an object recognition result, segmentation, pose estimation, and the like). Optionally, the predicted confidence 60 of the computer vision model 16 generated by the safety runtime monitor 45 may be combined with the computer vision model prediction 61 to provide a prediction with an uncertainty (or reliability) measure.

Either or both of the reliability indication data, and/or the prediction from the computer vision model combined with the reliability indication data, may be used by a subsystem of an autonomous system 46. As illustrated, one option is that a motion planning subsystem 63 of an autonomous system bases motion planning decisions upon the reliability indication data. For example, if a computer vision model 16 identifies a parking space pattern with reliability indication data that indicates a high degree of certainty, then the optional motion planning subsystem 63 may provide motion commands to a motion subsystem 64 of the vehicle to move the autonomous system into the parking space. However, if the computer vision model 16 identifies a parking space pattern with reliability indication data that indicates a low degree of certainty, then the optional motion planning subsystem 63 may provide motion commands to motion subsystem 64 as a vehicle to move the autonomous system beyond the unreliably identified parking space.

Advantageously, the computer-implemented method 100 according to the first aspect provides an online reliability or safety monitor capable of characterising the reliability of a computer vision model when observing a given scene. Optionally, the reliability indication data may be combined with the output of the computer vision model 16 to provide confidence information 60—in other words a probability that a scene observed by an input sensor at a given time instant is reliable. Optionally, the confidence information 60 may be used by a motion planner 63 or a autonomous system control system 64 for controlling wheel direction or speed.

The core of the computer vision model 16 is, for example, a deep neural network consisting of several neural net layers. However, other conventional model topologies may also be implemented according to the present technique. The layers compute latent representations which are higher-level representation of the input image. As an example, the specification proposes to extend an existing DNN architecture with latent variables representing the visual parameters which may have impact on the performance of the computer vision model, optionally according to a (global) sensitivity analysis aimed at determining relevance or importance or criticality of visual parameters. In so doing observations from verification are directly integrated into the computer vision model.

Generally, different sets of visual parameters (defining the world model or ontology) for testing or statistically evaluating computer vision model 16 can be defined and their implementation or exact interpretation may vary. This methodology enforces decision making based on empirical results 19, rather than experts' opinion alone and it enforces concretization 42 of abstract parameters 10. Experts may still provide visual parameters as candidates 10.

Box 1 illustrates a visual parameter specification which may function as a “world model”. When training a computer vision model, images may be synthetically generated within the visual parameter specification of box 1, for example. Alternatively, real-world images may be selected that are categorised according to the visual parameter specification of box 1, for example. Alternatively, the visual parameter specification of box 1 may form an experimental specification for obtaining further real-world or synthetic images.

Images obtained that satisfy specific values within the visual parameter specification, for example of box 1, may result in underperformance (high variance) of a computer vision model. Accordingly, it is desirable for a reliability or safety monitor of a computer vision model to alert downstream processes when such values are encountered in operation of the computer vision model.

| | |
|---|---|
| worldmodel = OrderedDict([ | (′spawn_point′, [0,3,6,9,12,15]), |
| | (′cam_yaw′, [−20, −10, 0, 10, |
| 20]) , | |
| | (′cam_pitch′, [−10, −5, 0, 5, |
| 10]), | |
| | (′cam_roll′ , [−10, −5, 0, 5, |
| 10]) , | |
| | (′cloudyness′, [0, 33, 66, 100]), |
| | (′precipitation′, [0, 50, 100]), |
| | (′precipitation_deposits′, [0, |
| 50, 100]), | |
| | (′sun_altitude_angle′, [−10, 0, |
| 33, 66, 100]), | |
| | (′sun_azimuth_angle′, [0, 45, 90, |
| 135, 180, 225, 270]), | |
| ]) | |

### Box 1—Example of a Visual Parameter Specification in “Python”

A visual data set of the observed scenes is a set of items representing either an image or a video, the latter being a sequence of images. Each item of visual data can be a numeric tensor with a video having an extra dimension for the succession of frames. An item of groundtruth data corresponding to one item of visual data is, for example a classification and/or regression result that the computer vision model should output in ideal conditions. For example, if the item of visual data is parameterized in part according to the presence of a wet road surface, and the presence, or not of a wet road surface is an intended output of the computer model to be trained, the groundtruth would return a description of that item of the associated item of visual data as comprising an image of a wet road.

Each item of groundtruth data can be another numeric tensor, or in a simpler case a binary result vector. A computer vision model is a function (i.e. a map) parametrized by model parameters that, upon training, can be learned based on the training data set using machine learning techniques. The computer vision model is configured to at least map an item of visual data to an item of predicted data. Items of visual data can be arranged (e.g. by embedding or resampling) so that it is well-defined to input them into the computer vision model 16. As an example, an image can be embedded into a video with one frame. One or more visual parameters define a visual state in that they contain information about the contents of the observed scene and/or represent boundary conditions for capturing and/or generating the observed scene. A latent representation of the computer vision model is an output of an intermediate (i.e. hidden) layer or a portion thereof in the computer vision model.

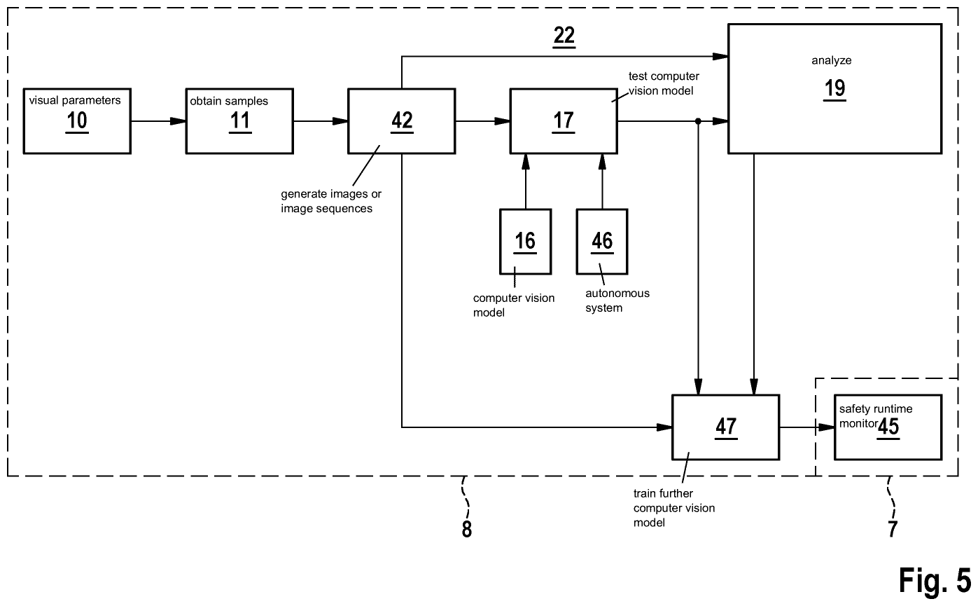

FIG. 5 schematically illustrates a general flow diagram according to an example, with like reference numerals from FIG. 1 adapted. The processes occurring inside dotted box 8 are typically performed “off-line”, or as part of a preparation or training process of the safety (or reliability) monitor 45. The processes occurring inside dotted box 7 are typically performed “on-line” as part of the execution of the safety monitor 45. The safety monitor 45 monitors an “online” version of a computer vision function 16 that is the same, or substantially similar, type of a computer vision function 16 used in the “off-line” process.

At step 10, a “world model” comprising a plurality of visual parameters 1 . . . n and representing value ranges for image acquisition and sampling is provided, according to a visual parameter specification language defined upon an operational design domain (ODD), of which “box 1” above is an example. At step 11, a plurality of samples of the visual parameters comprised in the “world model” are obtained, for example using combinatorial sampling. At step 42, a plurality of images, or image sequences are generated that are compliant with the samples of the “world model” from step 11. At step 42, the plurality of images, or image sequences are also generated with corresponding groundtruth to subsequently enable the accuracy of a prediction, regression or classification result to be verified.

As an example, a set of initial visual parameters and values or value ranges for the visual parameters in a given scenario can be defined (e.g. by experts). A simple scenario would have a first parameter defining various sun elevations relative to the direction of travel of the ego vehicle, although, as will be discussed later, a much wider range of visual parameters is possible.

A sampling procedure 11 generates a set of assignments of values to the visual parameters 10. Optionally, the parameter space is randomly sampled according to a Gaussian distribution. Optionally, the visual parameters are oversampled at regions that are suspected to define performance corners of the CV model. Optionally, the visual parameters are under sampled at regions that are suspected to define predictable performance of the CV model.

The next task is to acquire images in accordance with the visual parameter specification. A synthetic image generator, a physical capture setup and/or database selection 42 can be implemented allowing the generation, capture or selection of images and corresponding items of groundtruth according to the samples 11 of the visual parameters 10. Synthetic images are generated, for example, using the CARLA generator (e.g. discussed on https://carla.org). In the case of synthetic generation the groundtruth may be taken to be the sampled value of the visual parameter space used to generate the given synthetic image.

The physical capture setup enables an experiment to be performed to obtain a plurality of test visual data within the parameter space specified. Alternatively, databases containing historical visual data archives that have been appropriately labelled may be selected.

In a practical application, at step 42 the images or image sequences may be selected from a labelled database, generated using a synthetic image or image sequence generator such as the “CARLA” generator discussed elsewhere in the specification. Alternatively, the images or image sequences may be proactively captured (experimental obtained) according to the sampled visual parameters.

A computer vision model 16 having the same architecture and training as the intended “online” computer vision model is applied to the plurality of images generated at step 42. The computer vision model 16 may optionally be executed in a genuine autonomous system 16. The output of the testing step 17 is a series of performance scores for each image or image sequence characterising the accuracy of the computer vision model 16.

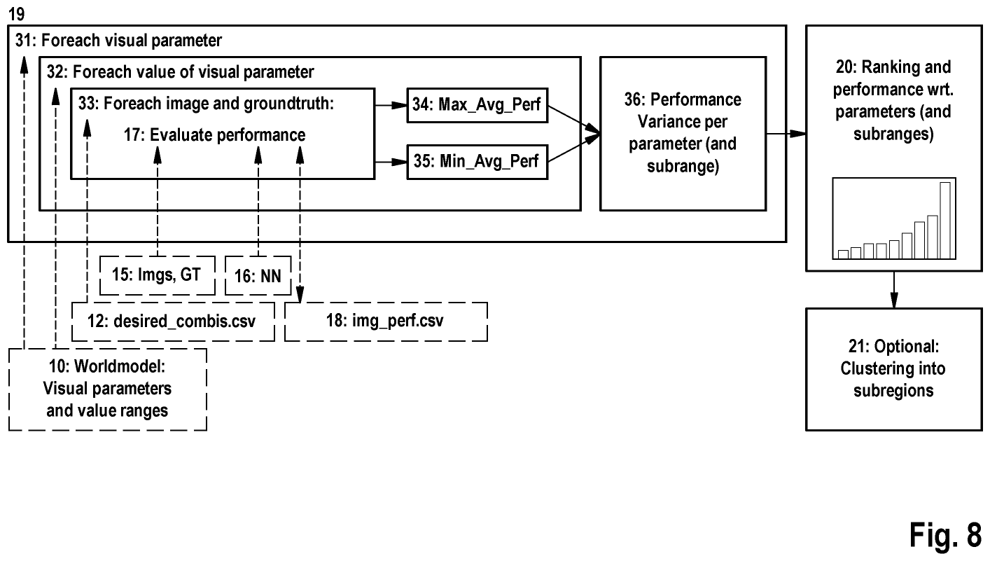

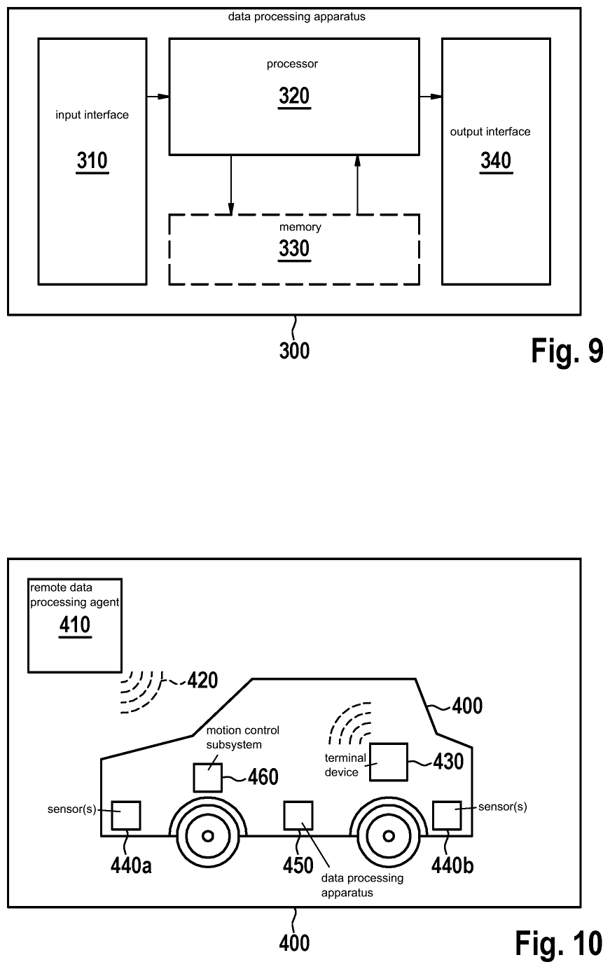

A global sensitivity analysis 19 (to be discussed in more detail subsequently with reference to FIG. 8) is configured to compare the series of performance scores obtained in step 17 with the original visual parameter definition sampled from step 11, for example, optionally using actual visual parameter information 22. Optionally, the sensitivity analysis 19 may include some partitioning parameter ranges of the visual parameter specification 10, or clustering regions of the visual parameter specification 10. The sensitivity analysis 19 may include ranking the visual parameter specification 10 to emphasise important visual parameters and deemphasise unimportant visual parameters. Important visual parameters may, for example, be those that lead to a high variance of the performance of the computer vision model.

In an embodiment, for each item in the image data set, a performance score can be computed based on a comparison between the prediction of one or more elements within the observed scenes, and the corresponding item of groundtruth data. The performance score may comprise one or any combination of: a confusion matrix, precision, recall, F1 score, intersection of union, mean average, and optionally wherein the performance score for each of the at least one item of visual data from the training data set can be taken into account during training. Performance scores can be used in the (global) sensitivity analysis, e.g. the sensitivity of parameters may be ranked according to the variance of performance scores when varying each visual parameter.

Furthermore, the visual data set of the observed scenes may comprise one or more of a video sequence, a sequence of stand-alone images, a multi-camera video sequence, a RADAR image sequence, a LIDAR image sequence, a sequence of depth maps, or a sequence of infra-red images. Alternatively, an item of visual data can, for example, be a sound map with noise levels from a grid of solid angles.

In an embodiment, the visual parameters may comprise one or any combination selected from the following list:
one or more parameters describing a configuration of an image capture arrangement, optionally an image or video capturing device, visual data is taken in or synthetically generated for, optionally, spatial and/or temporal sampling, distortion aberration, colour depth, saturation, noise, absorption;
one or more light conditions in a scene of an image/video, light bounces, reflections, reflectivity of surfaces, light sources, fog and light scattering, overall illumination; and/or
one or more features of the scene of an image/video, optionally, one or more objects and/or their position, size, rotation, geometry, materials, textures;
one or more parameters of an environment of the image/video capturing device or for a simulative capturing device of a synthetic image generator, optionally, environmental characteristics, seeing distance, precipitation characteristics, radiation intensity; and/or
image characteristics, optionally, contrast, saturation, noise;
one or more domain-specific descriptions of the scene of an image/video, optionally, one or more cars or road users, or one or more objects on a crossing.

In an embodiment, the computer vision model 16 may be configured to output at least one classification label and/or at least one regression value of at least one element comprised in a scene contained in at least one item of visual data. A classification label can for example refer to object detection, in particular to events like “obstacle/no obstacle in front of a vehicle” or free-space detection, i.e. areas where a vehicle may drive. A regression value can for example be a speed suggestion in response to road conditions, traffic signs, weather conditions etc. As an example, a combination of at least one classification label and at least one regression value would be outputting both a speed limit detection and a speed suggestion. When applying the computer vision model 16 (feed-forward), such output relates to a prediction. During training such output of the computer vision model 16 relates to the groundtruth GT data in the sense that on a training data set predictions (from feed-forward) shall be as close as possible to items of (true) groundtruth data, at least statistically.

As will be detailed subsequently, the safety (or reliability) run-time monitor 45 comprises a plurality of machine learning models (such as deep neural networks) trained using the result of the sensitivity analysis 19, the originally generated images 42, and the series of performance scores 17 based on the performance of the off-line computer vision model 16.

According to an embodiment, there is further provided:
processing the visual data using an online computer vision model 16 configured to perform a classification or regression on the visual data, to thereby characterise an element of the observed scene; and
generating a prediction of the observed scene, wherein the reliability indication data characterises the reliability of the prediction of the observed scene.

Therefore, the reliability indication data enables systems downstream of the online computer vision model 16 to obtain an indication of the salience of a prediction of an observed scene.

According to an embodiment, there is further provided:
communicating the reliability indication data of the online computer vision model to a motion control system of an autonomous system 400; and optionally
issuing one or more motion commands to the autonomous system via the motion control system based on the reliability indication data.

For example, the one or more motion commands may comprise a steering demand signal, a velocity, indicator light control, braking control, gear control, of an autonomous system. Alternatively, the one or more motion commands may comprise a higher-level definition such as a route plan across map, a robotic actuator movement plan, or an autonomous drone route, for example.

According to an embodiment, the subset of the set of visual parameters is obtained based on an automatic assessment of the sensitivity of an offline computer vision model (16) to visual parameters sampled from the set of visual parameters, wherein a high sensitivity represents a high variance between a predicted and an expected performance of the offline computer vision model.

Accordingly, a large number of potential image or image sequence scenarios can be modelled a priori, with an off-line computer vision model used to investigate the sensitivity of the offline computer vision model to changes in images or image sequences described by subsets of the visual parameters in the “world model”.

According to an embodiment, the offline computer vision model comprises the same, or same type of network and/or parameterization as the online computer vision model.

According to an embodiment, analysing the observed scene comprised in the visual data using the computer vision reliability model further comprises:
mapping, using a first trained machine learning model 47a, the visual data to the second set of visual parameters obtained using the sensitivity analysis of the first and/or second set of visual parameters obtained during the offline training phase of the computer vision reliability model 45.

Accordingly, input image or image sequence data can be correlated with a reduced set of visual parameters from a “world model”. A complete “world model” may comprise many tens of thousands or even millions of parameters relevant to the description of a visual scene to which a computer vision model is applied. However only a subset of the “world model” may be relevant for determining that a given prediction obtained using a computer vision model is a reliable prediction, or not.

According to an embodiment, analysing the observed scene comprised in the visual data using the computer vision reliability model further comprises:
mapping, using a second trained machine learning model 47b, the second set of visual parameters to the reliability indication data of the prediction of the mapping made by the first machine learning model.

For example, if the first trained machine learning model 47a recognises that a subset of visual parameters representing a sun angle that is directly ahead of the windshield of an ego vehicle at a low azimuth angle, the second trained machine learning model 47b may indicate that under these conditions, predicted road traffic signs can only be identified with a moderate degree of confidence.

FIG. 3 schematically illustrates a computer-implemented training method according to the second aspect.

According to a second aspect, there is provided a computer-implemented method 200 for training a computer vision reliability model comprising:
sampling 202 a set of visual parameters from a visual parameter specification;
obtaining 204 a set of items of visual data, and providing a set of items of groundtruth data corresponding to the set of items of visual data based on the sampled set of visual parameters, wherein the set of items of visual data and the set of items of groundtruth data form a training data set;
iteratively training 206 a first machine learning model to analyse at least one item of visual data from the set of items of visual data, and to output a prediction of a mapping of the at least one item of visual data to a subset of the set of visual parameters used to generate the item of visual data; and
iteratively training 208 a second machine learning model to predict reliability indication data of the prediction of the mapping made by the first machine learning model, wherein the reliability indication data is obtained by comparing the prediction of the mapping from the first machine learning model with a corresponding item of groundtruth data from the training data set.

FIG. 6 schematically illustrates training a machine learning model configured to function as a reliability monitor in greater detail. In particular, like system blocks are illustrated with like reference numerals. The safety (or reliability) monitor 45 comprises a first machine learning model 47a trained to predict visual parameters, given an input image. Optionally, the first machine learning model 47a is configured to predict the dominant or most important visual parameters of the world model present in a given input image. Optionally, the first machine learning model 47a performs as an artificial “bottle-neck” or parameter reduction stage. Optionally, the first machine learning model 47a reduces the potentially large number of visual parameters represented by the “world model” 10 by at least 50%, 60%, 70%, 80%, 90%, 95%, or 99%.

Optionally, the parameter reduction is performed using the result of a global sensitivity analysis 19. In other words, the “world model” may be considered to be a first set of visual parameters, and the second set of visual parameters may be considered to be a subset of the first set of visual parameters that cause a performance variance within the at least 500, 600, 700, 800, 900, 950, or 99% percentile range.

| | |
|---|---|
| second subset = OrderedDict( | |
| | (′sun_altitude_angle′) |
| | (′sun_azimuth_angle′) |
| ]) | |

### Box 2—Example of a Reduced Visual Parameter Specification in “Python”

Box 2 illustrates an example output of the training of 47a—a data structure comprising a list of two visual parameters from the original “world model” concerning sun direction relative to an ego vehicle that have an important effect in a given situation.

The iterative training 206 of the first machine learning model 47a is thus performed, for example, by inputting a large number of images 42 to the first machine learning model 47a, and inputting corresponding values of the samples 11 of the “world model”, to thus iteratively train the first machine learning model 47a to recognise which type of image maps to a given subset of important visual parameters.

The safety or reliability monitor 45 further comprises a second machine learning model 47b, optionally a second deep neural network. The function of the second machine learning model 47b is to predict the performance of a computer vision model 16 of the same type that the safety monitor 45 is intended to monitor when “online”. Accordingly, iterative training 208 of the second machine learning model 47b obtains a plurality of visual parameter samples 11, and corresponding image or image sequence test results 17 for corresponding images or image sequences 42 applied to an off-line computer vision model 16 of the same type as the online computer vision model that the safety monitor 45 is intended to monitor. The second machine learning model 47b thus learns how to predict the “online” performance of a computer vision function when certain combinations of visual parameter are observed from the results of an “off-line” test.

| | |
|---|---|
| uncertainty = OrderedDict( | |
| | (′sun_altitude_angle′ -> 80%) |
| | (′sun_azimuth_angle′ -> 40%) |
| ]) | |

### Box 3—Example of an Output of the Second Machine Learning Model “Python”

Box 3 illustrates an example output of the training of 47b—a data structure comprising a list of two visual parameters from the first machine learning model 47a ranked in order of their uncertainty.

The outcome of the training process 47 of the safety monitor 45 is a first machine learning model 47a capable of acquiring an input image or sequence of images, and outputting a reduced range of visual parameters from a “world model” 10 present in the acquired input image or sequence of images. The second machine learning model 47b receives the definition of the reduced range of visual parameters from the first machine learning model 47a, and uses it to predict the uncertainty of a computer vision model 16, when viewing the same image or sequence of images as input into the first machine learning model 47a. Accordingly, the functionality of a safety monitor or reliability monitor 45 can be trained into a composite machine learning model 45 optionally represented using a deep neural network.

Optionally, a subset of visual parameters 10 that the first machine learning model 47a and the second machine learning model 47b are trained to target are chosen on the basis of a sensitivity analysis 19.

According to an embodiment, wherein, when iteratively training a first machine learning model 47a, the subset of the set of visual parameters used to generate the item of visual data is obtained using a sensitivity analysis of the set of visual parameters from a visual parameter specification and corresponding predict reliability indication data predicted by the second machine learning model 47b.

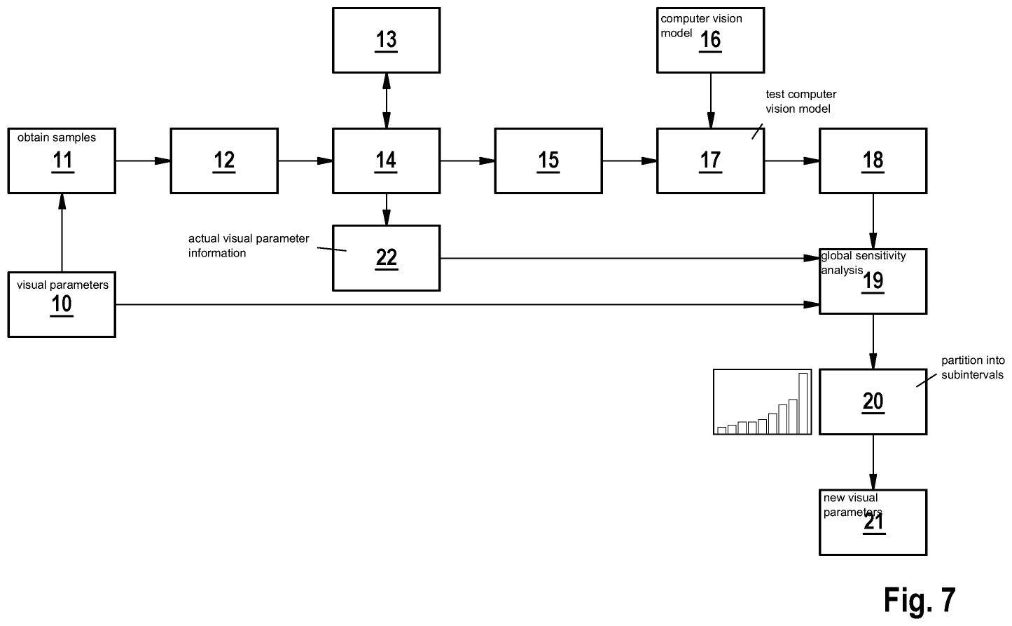

FIG. 7 schematically illustrates an example of global sensitivity analysis of visual parameters for computer vision functions.

In more detail, the training method comprises a first step of acquiring a set of initial visual parameters 10 and values or value ranges for the parameters are defined (e.g. by experts). Secondly, synthetic image generator, a data set, or a physical capturing setup is implemented allowing the generation 42 or capture of suitable images according to the visual parameters 10. Thirdly, an offline computer vision function is provided and optionally an offline autonomous system 46 which uses the computer vision function.

In an embodiment, generation step 42 outputs the actual visual parameter value combinations 22 of the generated/selected images, that may include image characteristics and statistics computed after image generation/capturing and that may deviate from the desired samples 11 of the “world model” of visual parameters.

The computer vision model 16 is tested 17, optionally as part of an autonomous system 46, using the image data 42. For every image, a performance score is evaluated such as a confusion matrix, precision, recall, F1 score, Intersection of union, mean average performance.

A global sensitivity analysis 19 is applied on the parameters 10 given the performance results (scores) per-image on a selected performance metric from testing step 17. The analysis computes the variance of the performance scores with respect to each visual parameter (10) and creates a ranking. The value intervals of visual parameters are optionally partitioned into subintervals 20 and the subintervals can optionally be treated as new dimensions 21 (new visual parameters).

The global sensitivity analysis 19 outputs a ranking/sorting of the visual parameters (optionally per subinterval) according to the variance of the performance scores. Optionally also clusters of conditions are created, for example if parameter1=“the camera is looking towards the sun” and parameter2=“the road is wet”, then the performance of the computer vision function 16 may be low (i.e. critical) and the parameters 1 and 2 are relevant (ranked high).

A composite model, for example a deep neural network 47, is trained to predict the confidence/safety of the CV function 16 as follows:

Firstly, a first model (such as a deep neural network) 47a is trained to map an input image (distribution, set, or sequence of images) 42 to a subset of the original visual parameters 10. The subset of visual parameters is selected based on the prioritization from global sensitivity analysis 19.

A second model (such as a deep neural network) 47b is trained to map the visual parameters to the test results 17, hence, the expected performance of the network.

The output of the training 47 is a runtime safety monitor 45 which maps input images (or image sequences etc.) to an uncertainty/confidence/safety prediction of the CV-function for that image (FIG. 3). The runtime safety monitor 45 contains a network 47a which maps the input image to visual parameters and a network 47b which maps the visual parameters to the output of 45.

Advantageously, a safety runtime monitor 45 for a computer vision model 16 of the same or similar type is provided. It predicts the uncertainty or confidence of the computer vision model. High uncertainty or low confidence denote cases where the computer vision model should not be trusted by downstream vehicle systems, such as route-planning software or motion control software.

In general, sensitivity analysis (or, more narrowly, global sensitivity analysis) can be seen as the numeric quantification of how the uncertainty in the output of a model or system can be divided and allocated to different sources of uncertainty in its inputs. This quantification can be referred to as sensitivity, or robustness. In the context of this specification, the model can, for instance, be taken to be the mapping,

Φ: X→Y

from visual parameters (or visual parameter coordinates) Xᵢ,i=1, . . . ,n based on which items of visual data have been captured/generated/selected to yield performance scores (or performance score coordinates) Yⱼ,j=1, . . . ,m based on the predictions and the groundtruth.

A variance-based sensitivity analysis, sometimes also referred to as the Sobol method or Sobol indices is a particular kind of (global) sensitivity analysis. To this end, samples of both input and output of the aforementioned mapping Φ can be interpreted in a probabilistic sense. In fact, as an example a (multi-variate) empirical distribution for input samples can be generated. Analogously, for output samples a (multi-variate) empirical distribution can be computed. A variance of the input and/or output (viz. of the performance scores) can thus be computed. Variance-based sensitivity analysis is capable of decomposing the variance of the output into fractions which can be attributed to input coordinates or sets of input coordinates. For example, in case of two visual parameters (i.e. n=2), one might find that 50% of the variance of the performance scores is caused by (the variance in) the first visual parameter (X₁), 20% by (the variance in) the second visual parameter (X₂), and 30% due to interactions between the first visual parameter and the second visual parameter. For n>2 interactions arise for more than two visual parameters. Note that if such interaction turns out to be significant, a combination between two or more visual parameters can be promoted to become a new visual dimension and/or a language entity. Variance-based sensitivity analysis is an example of a global sensitivity analysis.

Hence, when applied in the context of this specification, an important result of the variance-based sensitivity analysis is a variance of performance scores for each visual parameter. The larger a variance of performance scores for a given visual parameter, the more performance scores vary for this visual parameter. This indicates that the computer vision model is more unpredictable based on the setting of this visual parameter. Unpredictability when training the computer vision model 16 may be undesirable, and thus visual parameters leading to a high variance can be de-emphasized or removed when training the computer vision model.

In the context of this specification, the model can, for instance, be taken to be the mapping from visual parameters based on which items of visual data have been captured/generated/selected to yield performance scores based on the true and predicted items of groundtruth. An important result of the sensitivity analysis can be a variance of performance scores for each visual parameter. The larger a variance of performance scores for a given visual parameter, the more performance scores vary for this visual parameter. This indicates that the computer vision model is more unpredictable based on the setting of this visual parameter.

FIG. 8 schematically illustrates an example of global sensitivity analysis of visual parameters.

As an example, a nested loop is performed for each visual parameter 31, for each value of the current visual parameter 32, for each item of visual data and corresponding item of groundtruth 33 is captured, generated, and selected for the current value of the current visual parameter a prediction by 16 is obtained by e.g. applying the second method (according to the second aspect). In each such step, a performance score can be computed 17 based on the current item of groundtruth and the current prediction. In so doing the mapping from visual parameters to performance scores can be defined e.g. in terms of a lookup-table. It is possible and often meaningful to classify, group or cluster visual parameters e.g. in terms of subranges or combinations or conditions between various values/subranges of visual parameters. In FIG. 8, a measure of variance of performance scores (viz. performance variance) can be computed based on arithmetic operations such as e.g. a minimum, a maximum or an average of performance scores within one class, group or cluster.

Alternatively, a global sensitivity analysis can be performed by using a global sensitivity analysis tool 37. As an example, a ranking of performance scores and/or a ranking of variance of performance scores, both with respect to visual parameters or their class, groups or clusters can be generated and visualized. It is by this means that relevance of visual parameters can be determined, in particular irrespective of the biases of the human perception system. Also adjustment of the visual parameters, i.e. of the operational design domain (ODD), can result from quantitative criteria.

According to a third aspect, there is provided a data processing apparatus 300 configured to generate reliability indication data of a computer vision model, comprising an input interface 310, a processor 320, a memory 330, and an output interface 340. The input interface 310 is configured to obtain visual data comprising an input image or image sequence representing an observed scene, wherein the visual data is characterizable by a first set of visual parameters. The processor 320 is configured to analyse the observed scene comprised in the visual data using a computer vision reliability model sensitive to a second set of visual parameters. The second set of visual parameters comprises a subset of the first set of visual parameters, wherein the second set of visual parameters is obtained from the first set of visual parameters according to a sensitivity analysis applied to a plurality of parameters in the first set of visual parameters, wherein the sensitivity analysis is performed during a prior training phase of the computer vision reliability model. The processor 320 is configured to generate reliability indication data of the observed scene using the analysis of the observed scene. The output interface 340 is configured to output the reliability indication data of the computer vision model.

In an example, the data processing apparatus 300 is an electronic control unit (ECU) of a vehicle, an embedded computer, or a personal computer. In an embodiment, the data processing apparatus may be a server, or cloud-based server located remotely from the input 310 and/or output 340 interface. It is not essential that the processing occurs on one physical processor. For example, it can divide the processing task across a plurality of processor cores on the same processor, or across a plurality of different processors. The processor may be a Hadoop (TM) cluster, or provided on a commercial cloud processing service. A portion of the processing may be performed on non-conventional processing hardware such as a field programmable gate array (FPGA), an application specific integrated circuit (ASIC), one or a plurality of graphics processors, application-specific processors for machine learning, and the like.

A fourth aspect relates to a computer program comprising instructions which, when executed by a computer, causes the computer to carry out the first method or the second method.

A fifth aspect relates to a computer readable medium having stored thereon one or both of the computer programs.

The memory 330 of the apparatus 300 stores a computer program according to the fourth aspect that, when executed by the processor 320, causes the processor 320 to execute the functionalities described by the computer-implemented methods according to the first and/or second aspects. According to an example, the input interface 310 and/or output interface 340 is one of a USB interface, an Ethernet interface, a WLAN interface, or other suitable hardware capable of enabling the input and output of data samples from the apparatus 300. In an example, the apparatus 330 further comprises a volatile and/or non-volatile memory system 330 configured to receive input observations as input data from the input interface 310. In an example, the apparatus 300 is an automotive embedded computer comprised in a vehicle as in FIG. 10, in which case the automotive embedded computer may be connected to sensors 440a, 440b and motion control subsystem 460 present in the vehicle. For example, the input interface 310 of the apparatus 300 may interface with one or more of an engine control unit ECU providing velocity, fuel consumption data, battery data, location data and the like. For example, the output interface 340 of the apparatus 300 may interface with one or more of a plurality of brake actuators, throttle actuators, fuel mixture or fuel air mixture actuators, a turbocharger controller, a battery management system, the car lighting system or entertainment system, and the like.

FIG. 10 schematically illustrates an example of an autonomous system according to a sixth aspect. According to the sixth aspect, there is provided an autonomous system 400 comprising at least one sensor 440a, 440b configured to provide visual data comprising an input image or image sequence representing an observed scene, and a data processing apparatus 450 according to the third aspect configured to generate reliability indication data of a computer vision model.

The autonomous system 400 optionally further comprises a motion control subsystem 460, and the autonomous system is configured to generate or alter a motion command provided to the motion control subsystem based on reliability indication data obtained using the data processing apparatus 450.

A further aspect relates to a distributed data communications system comprising a remote data processing agent 410, a communications network 420 (e.g. USB, CAN, or other peer-to-peer connection, a broadband cellular network such as 4G, 5G, 6G, . . . ) and a terminal device 430, wherein the terminal device is optionally comprised in an automobile or robot. The server is configured to transmit to the terminal device via the communications network. As an example, the remote data processing agent 410 may comprise a server, a virtual machine, clusters or distributed services.

In other words, a reliability monitor 47 may be trained at a remote facility according to the second aspect, and may be transmitted to the vehicle such as an autonomous vehicle, semi-autonomous vehicle, automobile or robot via a communications network as a software update to the vehicle, automobile or robot.

The examples provided in the figures and described in the foregoing written description are intended for providing an understanding of the principles of this specification. No limitation to the scope of the present invention is intended thereby. The present specification describes alterations and modifications to the illustrated examples. Only the preferred examples have been presented, and all changes, modifications and further applications to these within the scope of the specification are desired to be protected.

1-15. (canceled)

16. A computer-implemented method for generating reliability indication data of a computer vision model, comprising the following steps:
obtaining visual data including an input image or image sequence representing an observed scene, wherein the visual data is characterizable by a first set of visual parameters;
analysing the observed scene included in the visual data using a computer vision reliability model sensitive to a second set of visual parameters, wherein the second set of visual parameters includes a subset of the first set of visual parameters, wherein the second set of visual parameters is obtained from the first set of visual parameters according to a sensitivity analysis applied to a plurality of parameters in the first set of visual parameters, wherein the sensitivity analysis is performed during an offline training phase of the computer vision reliability model;
generating reliability indication data of the observed scene using the analysis of the observed scene; and
outputting the reliability indication data of the computer vision model.

17. The computer-implemented method according to claim 16, further comprising:
processing the visual data using an online computer vision model configured to perform a classification or regression on the visual data, to thereby characterise an element of the observed scene; and
generating a prediction of the observed scene, wherein the reliability indication data characterizes the reliability of the prediction of the observed scene.

18. The computer-implemented method according to claim 16, further comprising:
communicating the reliability indication data of the online computer vision model to a motion control system of an autonomous system; and
issuing one or more motion commands to the autonomous system via the motion control system based on the reliability indication data.

19. The computer-implemented method according to claim 16, wherein the analysing of the observed scene included in the visual data using the computer vision reliability model further comprises:
mapping, using a first trained machine learning model, the visual data to the second set of visual parameters obtained using the sensitivity analysis of the first and/or second set of visual parameters obtained during the offline training phase of the computer vision reliability model.

20. The computer-implemented method according to claim 19, wherein the analysing of the observed scene included in the visual data using the computer vision reliability model further comprises:
mapping, using a second trained machine learning model, the second set of visual parameters to the reliability indication data of a prediction of the mapping made by the first machine learning model.

21. The computer-implemented method according to claim 16, wherein the visual data includes one or more of a video sequence, or a sequence of stand-alone images, or a multi-camera video sequence, or a RADAR image sequence, or a LIDAR image sequence, or a sequence of depth maps, or a sequence of infra-red images.

22. The computer-implemented method according to claim 16, wherein the visual parameters include one or any combination selected from the following list:
one or more parameters describing a configuration of an image capture arrangement including an image or video capturing device, and/or visual data taken in or synthetically generated for spatial and/or temporal sampling, and/or distortion aberration, and/or colour depth, and/or saturation, and/or noise, and/or absorption, and/or reflectivity of surfaces; and/or
one or more light conditions in a scene of an image/video, including light bounces, and/or reflections, and/or light sources, and/or fog, and/or light scattering, and/or overall illumination; and/or
one or more features of the scene of an image/video including: i) one or more objects, and/or ii) their position and/or size and/or rotation and/or geometry and/or materials and/or textures; and/or
one or more parameters of an environment of the image/video capturing device or for a simulative capturing device of a synthetic image generator, including environmental characteristics, and/or seeing distance, and/or precipitation characteristics, and/or radiation intensity; and/or
image characteristics including contrast and/or saturation and/or noise; and/or
one or more domain-specific descriptions of a scene of an image/video, including one or more cars or road users, or one or more objects on a crossing.

23. A data processing apparatus configured to generate reliability indication data of a computer vision model, comprising:
an input interface;
a processor;
a memory; and
an output interface;
wherein the input interface is configured to obtain visual data including an input image or image sequence representing an observed scene, wherein the visual data is characterizable by a first set of visual parameters,
wherein the processor is configured to analyse the observed scene included in the visual data using a computer vision reliability model sensitive to a second set of visual parameters, wherein the second set of visual parameters includes a subset of the first set of visual parameters, wherein the second set of visual parameters is obtained from the first set of visual parameters according to a sensitivity analysis applied to a plurality of parameters in the first set of visual parameters, wherein the sensitivity analysis is performed during an offline training phase of the computer vision reliability model;
wherein the processor is configured to generate reliability indication data of the observed scene using the analysis of the observed scene; and
wherein the output interface is configured to output the reliability indication data of the computer vision model.

24. A computer-implemented method for training a computer vision reliability model comprising the following steps:
sampling a set of visual parameters from a visual parameter specification;
obtaining a set of items of visual data, and providing a set of items of groundtruth data corresponding to the set of items of visual data based on the sampled set of visual parameters, wherein the set of items of visual data and the set of items of groundtruth data form a training data set;
iteratively training a first machine learning model to analyse at least one item of visual data from the set of items of visual data, and to output a prediction of a mapping of the at least one item of visual data to a subset of the set of visual parameters used to generate the item of visual data; and
iteratively training a second machine learning model to predict reliability indication data of the prediction of the mapping made by the first machine learning model, wherein the reliability indication data is obtained by comparing the prediction of the mapping from the first machine learning model with a corresponding item of groundtruth data from the training data set.

25. The computer-implemented method according to claim 24, wherein, when iteratively training the first machine learning model, the subset of the set of visual parameters used to generate the item of visual data is obtained using a sensitivity analysis of the set of visual parameters from a visual parameter specification and corresponding prediction reliability indication data predicted by the second machine learning model.

26. The computer-implemented method according to claim 25, wherein the subset of the set of visual parameters is obtained based on an automatic assessment of a sensitivity of an offline computer vision model to visual parameters sampled from the set of visual parameters, wherein a high sensitivity represents a high variance between a predicted and an expected performance of the offline computer vision model.

27. The computer-implemented method according to claim 26, wherein the offline computer vision model is the same, or same type of network and/or parameterization as an online computer vision model.

28. A non-transitory computer readable medium on which is stored a computer program including machine-readable instructions for generating reliability indication data of a computer vision model, the instruction, when executed by a processor, causing the processor to perform the following steps:
obtaining visual data including an input image or image sequence representing an observed scene, wherein the visual data is characterizable by a first set of visual parameters;
analysing the observed scene included in the visual data using a computer vision reliability model sensitive to a second set of visual parameters, wherein the second set of visual parameters includes a subset of the first set of visual parameters, wherein the second set of visual parameters is obtained from the first set of visual parameters according to a sensitivity analysis applied to a plurality of parameters in the first set of visual parameters, wherein the sensitivity analysis is performed during an offline training phase of the computer vision reliability model;
generating reliability indication data of the observed scene using the analysis of the observed scene; and
outputting the reliability indication data of the computer vision model

29. An autonomous system, comprising:
a sensor configured to provide visual data including an input image or image sequence representing an observed scene; and
a data processing apparatus configured to generate reliability indication data of a computer vision model, including:
an input interface,
a processor,
a memory, and
an output interface,
wherein the input interface is configured to obtain visual data including an input image or image sequence representing an observed scene, wherein the visual data is characterizable by a first set of visual parameters,
wherein the processor is configured to analyse the observed scene included in the visual data using a computer vision reliability model sensitive to a second set of visual parameters, wherein the second set of visual parameters includes a subset of the first set of visual parameters, wherein the second set of visual parameters is obtained from the first set of visual parameters according to a sensitivity analysis applied to a plurality of parameters in the first set of visual parameters, wherein the sensitivity analysis is performed during an offline training phase of the computer vision reliability model;
wherein the processor is configured to generate reliability indication data of the observed scene using the analysis of the observed scene; and
wherein the output interface is configured to output the reliability indication data of the computer vision model; and
a motion control subsystem, wherein the autonomous system is configured to generate or alter a motion command provided to the motion control subsystem based on the reliability indication data obtained using the data processing apparatus.
